(19) United States
(12) Patent Application Publication
(10) Pub. No.: US 2008/0032101 A1
(43) Pub. Date: Feb. 7, 2008

(54) Multilayer UV resistant thermoplastic composition

(76) Inventor: Jack Reilly, Blue Bell, PA (US)

Correspondence Address: Thomas F. Roland, Esq.;Arkema Inc., 2000 Market St., Philadelphia, PA, 19103, US

(21) Appl. No.: 11/492,173

(22) Filed: Jul. 24, 2006

(51) Int. Cl. B32B 27/18; B32B 27/36; B32B 27/30

(52) U.S. Cl. 428/213; 428/412; 428/522; 428/339; 428/411.1

(57) ABSTRACT

The present invention relates to a multi-layer thermoplastic composition with at least one inner ultraviolet (UV) blocking or filtering layer having a high level of UV absorber(s)/stabilizer(s), and an outer surface layer with little or no UV absorber(s)/stabilizer(s). Preferably the UV-blocking or filtering layer composition is an acrylic or polycarbonate, and at least one surface layer is an acrylic or an acrylic blend. Typically the multi-layer composition is formed using a co-extrusion process. The multi-layer thermoplastic composition preferably has a high luminous transmission in the visible wavelengths and a very low transmission in the UV wavelengths.

### FIELD OF THE INVENTION

The present invention relates to a multi-layer thermoplastic composition with at least one inner ultraviolet (UV) blocking or filtering layer having a high level of UV absorber(s)/stabilizer(s), and an outer surface layer with little or no UV absorber(s)/stabilizer(s). Preferably the UV-blocking or filtering layer composition is an acrylic or polycarbonate, and at least one surface layer is an acrylic or an acrylic blend. Typically the multi-layer composition is formed using a co-extrusion process.

One embodiment of the present invention relates to a multi-layer thermoplastic composition with a high luminous transmission in the visible wavelengths and a very low transmission in the UV wavelengths.

### BACKGROUND OF THE INVENTION

Acrylic compositions and articles made from them are well known for their clarity, sparkling color, surface gloss and weather resistance. Acrylic compositions exposed to UV radiation often contain some level of UV absorber to hinder UV degradation of the composition. The UV resistant acrylic in the composition can be monolithic as in U.S. Pat. No. 6,433,044, or can be used as an outer layer in a multi-layer composite as in US 2005/0084696; U.S. Pat. No. 4,576,870; U.S. Pat. No. 6,004,678 and EP 1,119,456. Clear acrylic sheets with higher levels of UV protection are often used to cover and protect photos, paintings, tapestries, and other art-work, as well as being used to protect museum displays, and show pieces. In order to protect these objects from degradation due to UV radiation, one or more UV absorbers/stabilizers at high levels are added to the thermoplastic to effectively filter out the harmful UV wavelength radiation and provide maximum protection to delicate objects.

Currently, commercial UV-blocking sheet is produced as a monolithic sheet. Unfortunately, during the manufacturing process, the UV absorbers which are present at high levels, tend to migrate to the surface and plate-out on the polishing rolls and/or other manufacturing equipment. As UV absorber builds up on the polishing rolls, the surface quality of the sheet deteriorates. The rolls need to be cleaned often during the manufacturing process—increasing manufacturing time and costs. One such monolithic product used in the picture framing industry has been Plexiglas® UF-5 from Arkema Inc. which is a methyl methacrylate/ethyl acrylate (MMA/EA) copolymer having a large amount of an ultraviolet filtering agent added to provide high UV filtering characteristics to this sheet product. Production of this product required frequent cleaning of the polish rolls in order to minimize the effects of plate-out.

One solution to mitigate plate-out is to use low volatile UV absorbers, which lessen, but do not eliminate the problem of plate-out. Another solution is to incorporate the UV absorber as part of the polymer chain to help prevent plate-out.

Another problem with monolithic sheet having a high level of UV absorber, is that during final use, UV absorber can migrate to the surface of the sheet and come into contact with objects being protected.

It has now been found that the problem of plate-out can be solved by co-extruding and/or laminating a thin thermoplastic layer having little or no UV absorber(s) or stabilizer(s) on each side of the thermoplastic layer having a high loading of UV absorber(s) or stabilizer(s).

### SUMMARY OF THE INVENTION

The invention relates to a multi-layer thermoplastic composition having three or more layers that are not intended to be separated, comprising:
a) two outer surface thermoplastic layers having less than 1000 ppm of total UV absorber(s) and/or stabilizer(s), and
b) an inner thermoplastic layer comprising greater than 0.1% by weight of one or more UV absorber(s) and/or stabilizer(s)

The invention also relates to extruded sheet, film, and profiles having the multi-layer composition, as well as to uses of the extruded sheet and profiles in final articles. The invention further relates to extruded sheet that has a film layer laminated onto at least one surface. It also includes articles produced by co-injection molding, multi-shot molding or film insert molding.

### BRIEF DESCRIPTION OF THE DRAWINGS

FIG. 1 shows the transmission spectra for comparative UV-blocking sheet (Ex 1 and 2) and the UV blocking sheet of the Invention (Ex 3a, 3b, and 3c).

### DETAILED DESCRIPTION OF THE INVENTION

The invention relates to a multi-layer thermoplastic composition, having at least one inner layer having a high level of UV absorber, and two surface layers with little or no UV absorber. By “multi-layer” composition is meant that the composition has at least three layers, and could have four, five, six or more separate layers. By outer (surface) layer is meant the layers that are exposed to the production equipment downstream of the die (i.e., polishing roll surfaces, vacuum sizing equipment, etc.). Note that when considering structures with 4 or more layers that the composition of an outer layer may also be used in one or more of the other layers. By inner layer is meant a layer that is not exposed to the production equipment downstream of the die. The inner and outer layers, as used herein, may be, and preferably are, adjacent to each other, though that is not a requirement for the invention.

The inner thermoplastic UV blocking layer is made from a thermoplastic material having dispersed therein at least 0.1% or more of one or more UV absorbers/stabilizers. The thermoplastic can be any polymer capable of forming a layer by an extrusion process. Examples of thermoplastics useful in the present invention include, but are not limited to polycarbonate (PC), polyesters (PET, PBT, APET, etc.), polyethylene terephthalate—glycol modified (PETG), polystyrene, high impact polystyrene (HIPS), styrene acrylonitrile (SAN), acrylonitrile-acrylate copolymer, acrylonitrile-methyl methacrylate copolymer, methyl methacrylate-styrene copolymer, methacrylate-butadiene-styrene (MBS) terpolymer, acrylonitrile-styrene-acrylate (ASA) terpolymer, acrylonitrile butadiene styrene (ABS) terpolymer, polyolefins, impact modified polyolefins, polycyclo-hexylethylene, cyclic olefin copolymers (COCs), polyvinyl chloride (PVC), impact modified PVC, chlorinated poly(vinyl chloride), polyvinylidene fluoride (PVDF), PVDF-acrylic copolymers, PVDF/acrylic blends, imidized acrylic polymer, acrylic polymers, impact modified acrylic polymers, etc. or mixtures thereof. Preferably, the inner thermoplastic layer with a high level of UV absorbers/stabilizers is PC, PETG, COC, an acrylic polymer or an acrylic-PVDF polymer blend. PC useful in the present invention denotes a polyester of carbonic acid, that is to say a polymer obtained by the reaction of at least one carbonic acid derivative with at least one aromatic or aliphatic diol. The preferred aromatic diol is bisphenol A, which reacts with phosgene or else, by trans-esterification, with ethyl carbonate.

“Acrylic polymers”, as used herein in reference to both the inner and outer layers, is meant to include polymers, copolymers and terpolymers formed from alkyl methacrylate and alkyl acrylate monomers, and mixtures thereof. The alkyl methacrylate monomer is preferably methyl methacrylate, which may make up from 50 to 100 percent of the monomer mixture. 0 to 50 percent of other acrylate and methacrylate monomers or other ethylenically unsaturated monomers, included but not limited to, styrene, alpha methyl styrene, acrylonitrile, and crosslinkers at low levels may also be present in the monomer mixture. Other methacrylate and acrylate monomers useful in the monomer mixture include, but are not limited to, methyl acrylate, ethyl acrylate and ethyl methacrylate, butyl acrylate and butyl methacrylate, iso-octyl methacrylate and acrylate, lauryl acrylate and lauryl methacrylate, stearyl acrylate and stearyl methacrylate, isobornyl acrylate and methacrylate, methoxy ethyl acrylate and methacrylate, 2-ethoxy ethyl acrylate and methacrylate, dimethylamino ethyl acrylate and methacrylate monomers. Alkyl(meth)acrylic acids such as methyl acrylic acid and acrylic acid can be useful for the monomer mixture. Most preferably the inner thermoplastic polymer is a copolymer having 70-99 weight percent of methyl methacrylate units and from 1 to 30 weight percent of one or more C₁₋₈ straight or branched alkyl acrylate units. In one embodiment the thermoplastic polymer is composed of 92-99 weight percent of methyl methacrylate units, and 1 to 8 weight percent of ethyl acrylate units. The thermoplastic polymer typically has a molecular weight of between 50,000 and 200,000, and preferably from 75,000 and 130,000.

Suitable commercially available poly(methyl methacrylate) type thermoplastic materials include Plexiglas® V(825), V(825) HID, V(046), V(045), V(052), V(920), VM, VS, V(044), etc. from Arkema Inc.

The thermoplastic polymer matrix is conveniently prepared by conventional cell casting or melt extrusion processes and is typically provided in particulate form. In addition, thermoplastic matrix materials may be prepared by a conventional bulk process (for example, a continuous flow stirred tank reactor (CFSTR) process), solution, suspension or emulsion polymerization techniques, in which case conventional isolation processes used to recover the polymer in particulate form include, for example, filtration, coagulation and spray drying.

The matrix may also include other modifiers or additives which are well known in the art. For example, the composition may contain colorants, impact modifiers, external lubricants, antioxidants, flame retardants or the like. If desired, ultraviolet absorbers, hindered amine light stabilizers (HALS), flow aids, and anti-static agents may also be added.

In one embodiment the inner thermoplastic polymer may contain from 0.1-70 weight percent of an impact modifier. Where optical clarity is needed, the impact modifier needs to be refractive index matched to the thermoplastic matrix polymer.

The inner layer also contains one or more UV absorbers and/or stabilizers at a level above 0.1 weight percent, and preferably above 0.2 weight percent total of all UV absorbers/stabilizers, based on the weight of the total inner layer containing the UV absorbers/stabilizers. This high level is needed to provide the level of UV blocking required. Suitable UV absorbers/stabilizers include, but are not limited to benzophenones, benzotriazoles, chlorobenzotriazoles, salicylates, monobenzoates, hindered amine light stabilizers (HALS), hindered benzoates, hindered phenolics, phosphates, thioesters, 2-(1-arylalkylidene) malonic acid esters, propanedioic acid-((4-methoxyphenyl)-methylene)-dimethyl ester, nano-sized titanium dioxide particles, butyl lactate, oxalanilides, triazines, benzoxazines, benzoxazinones, hydroxybenzotriazole derivatives, hydroxyphenyltriazine derivatives, and cyanoacrylic acid esters, or a combination thereof.

In one embodiment, a level of UV absorbers/stabilizers of less than 2 percent by weight is used, and preferably less than 1.5 weight percent. This is especially applicable to compositions in which the inner layer is polycarbonate.

The outer layers are thin co-extruded and/or laminated layers having a thickness of from 0.0005 to 0.495 inches, preferably from 0.001 to 0.300 inches, and most preferably from 0.0015 to 0.150 inches. The outer layers may be the same or different from each other in composition, level and type of any additives, and in thickness. Note that one outer layer may be a monolithic film or part of a multi-layer film that is laminated onto the surface just before the polishing rolls, and the other outer layer may be produced via co-extrusion in the same manufacturing step. The outer layers contain little or no UV absorber(s)/stabilizer(s) thus minimizing any plate-out during the manufacturing process. If a UV absorber/stabilizer is present, it can be the same or different from the UV absorber(s)/stabilizer(s) used in the inner UV blocking layer, and could be present at a level of up to 1000 ppm. The outer layer may be any optically transparent thermoplastic, the same or different from that of the inner layer, and selected from polycarbonate, polyester, polystyrene, styrene/acrylonitrile copolymer, polyolefins, cyclic olefin copolymers (COCs), poly(vinyl chloride), chlorinated poly(vinyl chloride), imidized acrylic polymer, or an acrylic polymer. Preferably, the outer thermoplastic is an acrylic polymer, known for its clarity, toughness, sparkling color, surface gloss, mar resistance and weather resistance. The outer polymer can also be a blend of impact modified acrylic or non-impact modified acrylic with other thermoplastics, such as polyvinylidene fluoride (PVDF).

The outer layers may contain an impact modifier at a level of from 0-70 weight percent, and preferably from 0 to 40 weight percent. The surface layers could be smooth or matte finish. Where optical clarity is needed, the impact modifier needs to be refractive index matched to the thermoplastic matrix polymer of the outer layer.

In addition to the thermoplastic polymer and impact modifiers in each of the inner and outer thermoplastic layers, each of the layers may also contain small amounts of typical additives, including but not limited to, stabilizers, plasticizers, coloring agents, pigments, antioxidants, surfactants, toner, and dispersing aids, and lubricants at levels typically of less than 5% and/or fillers, anti-static agents, refractive index matched additives, refractive index mis-matched additives or fillers at levels typically of less than 45%.

In one preferred embodiment, the multi-layer thermoplastic composition is a three-layer co-extruded sheet or profile having an inner UV-blocking layer, and two outer layers of the same composition. The outer layer thickness is about 0.0005 to 0.005 inches.

In the multi-layer composition of the invention, the outer layer is not intended to be separated from the inner layer, which may or may not be directly attached thereto (i.e., a protective film masking material commonly used in the sheet industry is not considered as part of the multi-layer structure because it is intended to be removed prior to use in the application. Furthermore, protective films are typically applied downstream of the polishing rolls or sizing equipment, and hence have no effect on plate-out.).

The multi-layer composition may be formed by laminating a film layer (outer layer) onto at least one surface of the inner layer. It may also include compositions formed into articles by co-injection molding, multi-shot molding or film insert molding.

The multi-layer thermoplastic composition of the invention is preferably formed by co-extrusion of the inner and outer layers. The extruded sheet, film or profile has a thickness of from 0.001 inches to about 1 inch, and preferably 0.0015 to 0.5 inches, depending on the requirements of the final application.

The co-extruded composition may be produced by a co-extrusion process comprised of two or more extruders converting plastic resin materials into molten plastic. Typically, there is a minimum of a primary extruder and a secondary extruder, but there may also be additional extruders, such as a tertiary extruder, etc. The primary extruder is usually the largest extruder and has the highest throughput rate compared to the other individual extruder(s). Therefore, in a 3-layer sheet configuration, the resin used to comprise the inner, or thicker layer is typically fed into the primary extruder and the surface layer resin used to comprise the outer or thinner layers is typically fed into the secondary extruder when using a co-extrusion set-up consisting of 2 extruders. Each of these extruders converts the resins fed to them into molten polymer, separately. The melt streams are then combined typically in a feedblock system, a multi-manifold die set-up, or a combination of both. Once the plastic melt streams are selectively layered and co-mingled in the feedblock, the combined melt stream exits the feedblock and enters the die where the combined melt stream is spread to the width of the die. The molten plastic extrudate is then polished between highly polished chrome-plated, temperature-controlled rolls. These rolls polish and cool the sheet to the desired overall thickness. Note that a multi-manifold die may also be used to achieve a layered sheet instead of a feedblock system. The polymer melt streams enter into the multi-manifold die separately and are selectively combined and spread to the width of the die all within the multi-manifold die.

Typical process conditions for 3-layer, sheet co-extrusion using a primary and secondary extruders and a feedblock/die assembly are listed below:

| Primary Extruder | Conditions |
|---|---|
| Barrel Zones: | 199–320° C. |
| Screw Speed: | 50–85 RPM (revolutions per minute) |

| Secondary Extruder | Conditions |
|---|---|
| Barrel Zones: | 221–320° C. |
| Screw Speed: | 10–40 RPM (revolutions per minute) |

| Feedblock | Temperature |
|---|---|
| Zones: | 232–320° C. |

| Die | Temperature |
|---|---|
| Zones | 221–320° C. |

| Polishing Rolls | Temperature |
|---|---|
| All | 80–140° C. |

The advantage of the present composition is that it minimizes plate-out of the UV absorbers/stabilizers, and other volatile additives in the composition. The composition of the invention can be co-extruded into a sheet, film or a profile. The co-extruded sheet, film or profile can then be further processed into a final article.

The thin outer layer of the multi-layer composition minimizes migration of the UV absorber(s)/stabilizer(s) and other volatile additives both during the manufacturing process, and during use as a final article. Thus, in addition to preventing plate-out on the polishing rollers, the outer layer can also prevent contact of the additives with photos, and other artwork that it is protecting, as the outer protective layer is on both sides of the UV blocking layer.

The multi-layer sheet or profile of the invention is especially useful in protecting delicate objects from damage due to UV radiation. Some typical uses include picture frame glazing, glazing for tapestries and other art work, as casing for historical documents and other valuable objects in settings such as museums, historic sites, etc.

In one embodiment, the multi-layer composition is described as clear or transparent. In another embodiment, it is not clear or transparent but instead is translucent or opaque. The solution to the plate-out problem is independent of whether the multi-layer composition is transparent or not.

The multi-layer sheet or profile may be subjected to any secondary treatment, such as coatings, decorative inks, the addition of pealable protective layers, etc.

### EXAMPLES

In the Examples below, all percentages are percentage by weight, unless otherwise noted.

### Example 1

### Comparative

A monolithic sheet was produced having 0.3% of a benzotriazole UV absorber [2-(3′-5′-di-tert-butyl-2′hydroxyphenyl)-5-chlorobenzotriazole] in an acrylic matrix (Plexiglas® V046) consisting of a copolymer of methylmethacrylate and ethyl acrylate, and having a melt flow rate of about 2 g/10 minutes when measured in accordance with ASTM D 1238, Condition 230° C./3.8 kg, procedure A. A concentrate resin containing 9.9% of the UV absorber in an acrylic matrix was blended with another acrylic resin in the feed hopper of the sheet extruder to produce the monolithic sheet having 0.3% UV absorber. A protective film masking material is applied to the sheet downstream of the polishing rolls.

### Example 2

### Comparative

Example 2 is another monolithic sheet having the same composition and made by the same process as that of Example 1.

### Example 3

### Of the Invention

A three-layer acrylic composition was produced by co-extrusion. The center or inner layer contains 0.3% of a benzotriazole UV absorber [2-(3′-5′-di-tert-butyl-2′hydroxyphenyl)-5-chlorobenzotriazole] in an acrylic matrix (Plexiglas® V046). The acrylic surface layers were produced using the same resin. This resin was the same acrylic matrix (i.e. Plexiglas® V046) but it contained less than 100 ppm of a different a benzotriazole UV absorber [2-(2′-hydroxy-5′-methylphenyl)benzotriazole]. The thickness of each outer layer was about 0.004 inches and very uniform across the sheet width. A protective film masking material is applied to the sheet downstream of the polishing rolls.

### Example 4

### Transmission Spectra

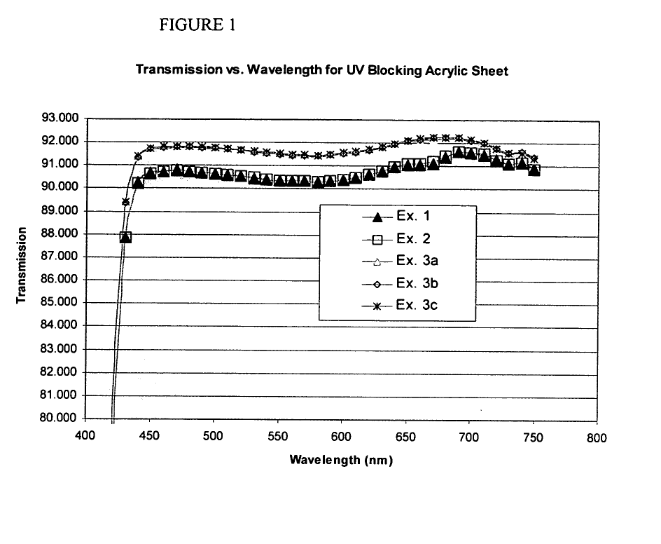

Transmission spectra were measured on samples of Example 1 and Example 2. Spectra on the sample of Example 3 was measured on each side of the sheet (3a, 3c) and in the center of the sheet (3b). Spectra were measured using a Macbeth® Color Eye® 7000 spectrophotometer (Division of Kollmorgen Instruments Corporation) using Illuminate C and a 2° observer. The equipment was calibrated in transmission mode using a barium sulfate standard. CIE tristimulus Y values were calculated in conformance with ASTM E 308 and used as a measure of luminous transmission. The transmission data is shown in FIG. 1. Note that deposits on the polishing rolls were observed when producing sheet samples in accordance with Examples 1 and 2, respectively. Also note that no deposits were observed on the polishing rolls while producing samples in accordance with Example 3. The higher transmission values for samples produced in Example 3 may be at least partially attributable to the higher surface quality enabled by the minimization of deposits on the polishing rolls during its manufacture.

### Example 5

### Of the Invention

A three-layer acrylic composition is produced by co-extrusion. The structure is asymmetrical with the inner layer containing about 0.3% of a benzotriazole UV absorber [2-(3′-5′-di-tert-butyl-2′hydroxyphenyl)-5-chlorobenzotriazole] in an acrylic matrix (Plexiglas® V046). The “smooth” acrylic surface layer on one side is produced using a Plexiglas® V046 resin that contains less than 100 ppm of a different benzotriazole UV absorber [2-(2′-hydroxy-5′-methylphenyl)benzotriazole]. The acrylic surface layer on the second side has a non-glare surface and is produced using a Plexiglas® V046 resin that contains less than 100 ppm of a different benzotriazole UV absorber [2-(2′-hydroxy-5′-methylphenyl)benzotriazole] but also contains about 5% of cross-linked particles to provide the non-glare surface finish. The preparation of the resin used to produce this surface layer is described below. The thickness of the non-glare outer layer is about 0.004 inches. The thickness of the “smooth” surface layer is about 0.002 inches. The thickness of each surface layer is very uniform across the sheet width.

### Preparation of the Non-Glare Cap (Outer) Layer

Crosslinked beads comprised of a 96% methyl methacrylate/4% ethyl acrylate copolymer with allyl methacrylate used as the crosslinking agent, that are substantially spherical, having a mean particle diameter of about 10 to 32 microns, wherein 90% of the particles by weight are less than 40 microns in diameter, and a refractive index (n_{D}) of 1.4907 are melt blended into an acrylic molding resin (methyl methacrylate/ethyl acrylate 96/4) at 5% by weight. The refractive index (n_{D}) of the acrylic molding resin used above is measured as 1.4935 in accordance with ASTM D 542. Hence the refractive index of the beads are very similar compared to that of the acrylic matrix.

### Preparation of the Clear Substrate Layer and Co-Extruded Sheet:

The above described non-glare, cap layer resin was fed into a secondary extruder. The same acrylic resin that was used as the matrix of the cap layer resin (methyl methacrylate/ethyl acrylate 96/4), but containing 0.3% UV absorber, was fed separately into the primary extruder. This is considered as the inner layer in this example. Additionally, the resin used to produce the “smooth” acrylic surface is fed into a tertiary extruder.

A co-extrusion setup is used whereby the melt streams from each of these extruders are fed to a feedblock/die assembly where the melts are layered and spread to the width of the die. The layered extrudate is subsequently polished between a series of polishing rolls to yield 0.118 inch thick sheet with a smooth, glossy finish on 1 side and a non-glare surface on the other side. Cap layer thicknesses in the range of 0.002 to 0.010 inches yields the best balance of properties. No plate-out deposits are observed and the resultant sheet has excellent UV blocking and transparency properties.

### Example 6

### Of the Invention

A three-layer acrylic composition is produced by co-extrusion. The structure is asymmetrical with the center or inner layer containing about 0.3% of a benzotriazole UV absorber [2-(3′-5′-di-tert-butyl-2′hydroxyphenyl)-5-chlorobenzotriazole] in an acrylic matrix (Plexiglas® V046). The “smooth” acrylic surface layer on one side is produced using a Plexiglas® V046 resin that contains less than 100 ppm of a different benzotriazole UV absorber [2-(2′-hydroxy-5′-methylphenyl)benzotriazole]. The acrylic surface layer on the second side has a textured surface and is produced using a MMA/EA acrylic matrix resin that contains less than 100 ppm of a different benzotriazole UV absorber [2-(2′-hydroxy-5′-methylphenyl)benzotriazole] but also contains about 30% of a cross-linked particle to provide the textured finish. The preparation of the resin used to produce this textured, outer surface layer is described below. The thickness of the textured outer layer is about 0.010 inches. The thickness of the “smooth” outer layer is about 0.004 inches. The thickness of each outer layer is uniform across the sheet width.

### Preparation of the Textured Cap Layer

Crosslinked beads comprised of a 74.3% methyl methacrylate/24.8% styrene copolymer with allyl methacrylate used as the crosslinking agent, that are substantially spherical, having a mean particle diameter of about 15 to 70 microns, wherein 90% of the particles by weight are less than 100 microns in diameter, and a refractive index (n_{D}) of 1.515 are melt blended into an acrylic molding resin (methyl methacrylate/ethyl acrylate 96/4) at 40% by weight. The refractive index (n_{D}) of the acrylic molding resin used above is measured as 1.4935 in accordance with ASTM D 542. Hence the refractive index of the beads are different compared to that of the acrylic matrix.

### Preparation of the Substrate Layer and Co-Extruded Sheet:

The above described textured, cap layer resin was fed into a secondary extruder. The same acrylic resin composition that was used as the matrix of the cap layer resin (methyl methacrylate/ethyl acrylate 96/4) but containing 0.3% UV absorber was fed separately into the primary extruder. Additionally, the resin used to produce the “smooth” acrylic surface is fed into a tertiary extruder.

A co-extrusion setup is used whereby the melt streams from each of these extruders are fed to a feedblock/die assembly where the melts are layered and spread to the width of the die. The layered extrudate is subsequently polished between a series of polishing rolls to yield 0.236 inch thick sheet with a smooth, glossy finish on 1 side and a textured surface on the other side. Cap layer thicknesses in the range of 0.002 to 0.010 inches seemed to yield the best balance of properties. No plate-out deposits are observed and the resultant sheet has excellent UV blocking and high luminous transmission properties.

### Example 7

### Of the Invention

A three-layer acrylic composition is produced by co-extrusion. The structure is symmetrical with the center or inner layer containing about 0.3% of a benzotriazole UV absorber 5 [2-(3′-5′-di-tert-butyl-2′hydroxyphenyl)-5-chlorobenzotriazole] in an acrylic matrix (Plexiglas® V046). Each acrylic surface layer has a non-glare surface and is produced using a Plexiglas® V046 resin that contains less than 100 ppm of a different benzotriazole UV absorber [2-(2′-hydroxy-5′-methylphenyl)benzotriazole] but also contains about 5% of a cross-linked particle to provide the non-glare surface finish. The preparation of the resin used to produce this surface layer is described in Example 5 above. The thickness of each outer layer is about 0.004 inches and very uniform across the sheet width.

### Example 8

### Of the Invention

A three-layer composition is produced by co-extrusion using a multi-manifold die instead of a feedblock setup previously described. The structure is asymmetrical with the thicker substrate layer residing on one surface. The substrate layer is a high impact polystyrene (HIPS) that contains less than 1000 ppm of a UV absorber and is considered as one of the outer layers. The layer adjacent (i.e., middle or inner layer) to the polystyrene is a 60% MMA/40% BMA acrylic copolymer that contains at least 0.1% UV absorbers or stabilizers. The thickness of this layer is about 0.010″. The other outer layer of this structure is an MMA/EA copolymer that contains less than 100 ppm of a UV absorber. The thickness of this outer layer is about 0.002″ thick. The overall sheet thickness is about 0.118″ thick. The HIPS layer (1 outer layer) is protected on one side from the UV by the middle or inner layer and the other outer layer provides a high gloss surface finish uninhibited by the detriments associated with plate-out.

### Example 9

### Of the Invention

A five-layer composition is produced by co-extrusion. The structure is symmetrical with the thicker substrate layer residing in the center. The substrate layer is a high impact polystyrene (HIPS). Each layer adjacent to the HIPS (i.e., middle layer) is a 60% MMA/40% BMA acrylic copolymer that contains at least 0.1% UV absorbers or stabilizers. The thickness of each of these inner layers is about 0.010″. Each outer layer of this structure is an MMA/EA copolymer that contains less than 100 ppm of a UV absorber. The thickness of each outer layer is about 0.002″ thick. The overall sheet thickness is about 0.118″ thick. The HIPS layer is protected on each side from the UV by the adjacent inner layer and the outer layers provide a high gloss surface finish uninhibited by the detriments associated with plate-out.

### Example 10

### Of the Invention

A three-layer acrylic composition was produced by co-extrusion using a feedblock set-up. The center or inner layer contains 0.3% of a benzotriazole UV absorber [2-(3′-5′-di-tert-butyl-2′hydroxyphenyl)-5-chlorobenzotriazole] in an acrylic matrix (Plexiglas® V046). The acrylic surface layers are produced using the same acrylic matrix (i.e. Plexiglas® V046) but it contains less than 100 ppm of a different a benzotriazole UV absorber [2-(2′-hydroxy-5′-methylphenyl)benzotriazole] and is blended with about 10% PVdF resin. The thickness of each outer layer is about 0.002 inches and very uniform across the sheet width. No plate-out deposition is observed.

### Example 11

### Of the Invention

A five-layer composition is produced by co-extrusion. The structure is symmetrical with the thicker substrate layer residing in the center. The substrate layer is PC. Each layer adjacent to the PC (i.e., middle layer) is a PC inner layer that contains at least 0.1% UV absorbers or stabilizers. The thickness of each of these inner layers is about 0.003 inches. Each outer surface layer of this structure is an impact-modified, MMA/EA copolymer that contains less than 1000 ppm of a UV absorber. The thickness of each outer layer is about 0.002 inches. The overall sheet thickness is about 0.177 inches. The PC layer is protected on each side from the UV-stabilized PC in the adjacent inner layers and the outer layers provide a high gloss surface finish unihibited by the detriments associated with plate-out.

What is claimed is:

1. A multi-layer thermoplastic composition having three or more layers that are not intended to be separated, comprising:
a) two outer surface thermoplastic layers, one on each side of an inner layer having less than 1000 ppm of total UV absorber(s) and/or stabilizer(s), and
b) the inner thermoplastic layer comprising greater than 0.1% by weight of one or more UV absorber(s) and/or stabilizer(s),
wherein the inner thermoplastic layer comprises more UV absorber(s) and/or stabilizer(s) than the outer surface thermoplastic layers, wherein each outer layer independently has a thickness of from 0.0005 to 0.495 inches, and wherein at least one outer layer is either:
a. a transparent thermoplastic selected from the group consisting of polyester, polystyrene, styrene/acrylonitrile copolymer, polyolefins, cyclic olefin copolymers (COCs), poly(vinyl chloride), chlorinated poly(vinyl chloride), imidized acrylic polymer, and an acrylic polymer; or
b. a blend of impact modified acrylic or non-impact modified acrylic with other thermoplastics, such as polyvinylidene fluoride (PVDF).

2. The multi-layer thermoplastic composition of claim 1, wherein said multi-layer composition is formed by co-extrusion, film lamination, or combination thereof.

3. The multi-layer composition of claim 1 wherein said inner thermoplastic layer is a polycarbonate, an acrylic polymer, or an acrylic polymer blend.

4. The multi-layer composition of claim 3 wherein said inner layer is an acrylic homopolymer or copolymer having at least 50% by weight of methyl methacrylate units.

5. The multi-layer composition of claim 4 wherein said inner layer comprises a copolymer having 70-99 weight percent of methyl methacrylate units and from 1 to 30 weight percent of one or more C₁₋₈ alkyl acrylate units.

6. The multi-layer composition of claim 1 wherein said inner layer comprises greater than 0.2 weight percent of UV absorber(s) and/or stabilizer(s).

7. The multi-layer composition of claim 1 wherein said inner layer comprises from 0.1 to less than 2 weight percent of UV absorber(s) and/or stabilizer(s).

8. The multi-layer composition of claim 1 wherein said inner layer comprises either a polycarbonate having from 0.1 to less than 2 weight percent of UV absorber(s) and/or stabilizer(s); or an acrylic polymer, or an acrylic blend having from 0.1 to 15 weight percent of UV absorber(s) and/or stabilizer(s),

9. The multi-layer composition of claim 1 wherein said UV absorber(s) in said inner and each outer layer can be the same or different and are selected from the group consisting of benzophenones, benzotriazoles, chlorobenzotriazoles, salicylates, monobenzoates, hindered amine light stabilizers (HALS), hindered benzoates, hindered phenolics, phosphates, thioesters, 2-(1-arylalkylidene) malonic acid esters, propanedioic acid-((4-methoxyphenyl)-methylene)-dimethyl ester, nano-sized titanium dioxide particles, butyl lactate, oxalanilides, triazines, benzoxazines, benzoxazinones, hydroxybenzotriazole derivatives, hydroxyphenyltriazine derivatives, and cyanoacrylic acid esters, or a combination thereof.

10. The multi-layer composition of claim 1 wherein one or more of the layers contain impact modifiers at a level of from 0.1-70 percent by weight, based on the total weight of the layer, wherein the level and type of impact modifier in each layer may be the same or different form that of other layers.

11. The multi-layer composition of claim 1 wherein at least one outer layer contains no UV absorber and/or stabilizer(s).

12. (canceled)

13. The multi-layer composition of claim 1 wherein the two outermost thermoplastic layers contain less than 100 ppm of total UV absorber(s) and/or stabilizer(s).

14. The multi-layer composition of claim 1 wherein at least one outer layer comprises an acrylic polymer, or an acrylic polymer/poly vinylidene fluoride blend.

15. The multi-layer composition of claim 1 wherein said composition comprises a sheet, film or extruded profile, having a thickness of from 0.001 to 1 inches.

16. An article comprising the multi-layer composition of claim 1.

17. The article of claim 16 comprising said multi-layer composition as a glazing material.

18. The article of claim 17 comprising a protective covering for protecting photos, paintings, tapestries, and other art work, and museum displays.
